(19) United States
(12) Patent Application Publication
(10) Pub. No.: US 2025/0167248 A1
(43) Pub. Date: May 22, 2025

(54) RECYCLED ALUMINUM ALLOYS FOR USE IN CURRENT COLLECTORS IN LITHIUM-ION BATTERIES

(71) Applicant: Novelis Inc., Atlanta, GA (US)

(72) Inventors: Martti Kaempgen, Hann Muenden (DE); DaeHoon Kang, Canton, GA (US); Diptarka Majumdar, Cumming, GA (US); Rajesh Gopalaswamy, Alpharetta, GA (US); Sazol Kumar Das, Acworth, GA (US); Lawrence Stevenson Kramer, Dayton, MD (US)

(21) Appl. No.: 19/027,691

(22) Filed: Jan. 17, 2025

Related U.S. Application Data
(63) Continuation-in-part of application No. 18/866,600, filed on Jan. 1, 0001.
(60) Provisional application No. 63/366,556, filed on Jun. 17, 2022.

(51) Int. Cl. H01M 4/66; C22C 21/00; C22F 1/04; H01M 4/02; H01M 4/75

(52) U.S. Cl. CPC H01M 4/662; C22C 21/00; C22F 1/04; H01M 4/75; H01M 2004/028

(57) ABSTRACT

Described are battery components including a current collector and a coating layer disposed over at least a portion of a surface of the current collector. The current collector can include a recycled content aluminum alloy. In some examples, the current collector can include from 50% to 100% recycled aluminum content. The recycled content aluminum alloy may be, for example, a 3xxx series aluminum alloy or a 5xxx series aluminum alloy.

### CROSS-REFERENCE TO RELATED APPLICATIONS

This application is a continuation-in-part of U.S. application Ser. No. 18/866,600, filed on Nov. 18, 2024, which is a national phase application of International Application No. PCT/US2023/025504, filed on Jun. 16, 2023, which claims the benefit of and priority to U.S. Provisional Application No. 63/366,556, filed on Jun. 17, 2022, which are incorporated by reference in their entireties for all intents and purposes.

### FIELD

The present disclosure relates to metallurgy generally and more specifically to high recycle content aluminum alloys to produce thin-gauge foils for battery components, including improving battery current collectors and other components with recycled aluminum alloys.

### BACKGROUND

In conventional lithium-ion batteries, aluminum is used as a cathode current collector. Typically, cathode current collectors comprise aluminum alloys containing relatively high amounts of or very pure aluminum. Anode current collectors, in comparison, commonly comprise copper. These materials tend to be used because of their high electrical conductivity and electrochemical stability at the potentials encountered in their respective electrodes.

### SUMMARY

Environmental concerns call for increased recycled source content within aluminum alloy products. For example, recycled content aluminum alloys are commonly used in beverage cans. However, increasing the recycled source content of aluminum alloy products used in batteries and battery components, such as lithium-ion batteries, may reduce the stability of the aluminum alloy products and/or the lithium-ion batteries and may result in reduced battery performance, such as due to the lower electrical conductivity of high-recycle content aluminum.

Described herein are battery components such as current collectors that comprise a recycled content aluminum alloy. In any examples, the current collector may comprise from 50% to 100% recycled aluminum content, such as 50% recycled aluminum content, 51% recycled aluminum content, 52% recycled aluminum content, 53% recycled aluminum content, 54% recycled aluminum content, 55% recycled aluminum content, 56% recycled aluminum content, 57% recycled aluminum content, 58% recycled aluminum content, 59% recycled aluminum content, 60% recycled aluminum content, 61% recycled aluminum content, 62% recycled aluminum content, 63% recycled aluminum content, 64% recycled aluminum content, 65% recycled aluminum content, 66% recycled aluminum content, 67% recycled aluminum content, 68% recycled aluminum content, 69% recycled aluminum content, 70% recycled aluminum content, 71% recycled aluminum content, 72% recycled aluminum content, 73% recycled aluminum content, 74% recycled aluminum content, 75% recycled aluminum content, 76% recycled aluminum content, 77% recycled aluminum content, 78% recycled aluminum content, 79% recycled aluminum content, 80% recycled aluminum content, 81% recycled aluminum content, 82% recycled aluminum content, 83% recycled aluminum content, 84% recycled aluminum content, 85% recycled aluminum content, 86% recycled aluminum content, 87% recycled aluminum content, 88% recycled aluminum content, 89% recycled aluminum content, 90% recycled aluminum content, 91% recycled aluminum content, 92% recycled aluminum content, 93% recycled aluminum content, 94% recycled aluminum content, 95% recycled aluminum content, 96% recycled aluminum content, 97% recycled aluminum content, 98% recycled aluminum content, 99% recycled aluminum content, or 100% recycled aluminum content.

In some examples, the current collector can comprise a 2xxx series aluminum alloy, 3xxx series aluminum alloy, a 4xxx series aluminum alloy, a 5xxx series aluminum alloy, a 6xxx series aluminum alloy, or a 7xxx series aluminum alloy. In some examples, the current collector does not include a 1xxx series aluminum alloy or an 8xxx series aluminum alloy. In any examples, the current collector can have a thickness from 0.005 mm to 0.5 mm, such as from 0.005 mm to 0.025 mm, from 0.025 mm to 0.05 mm, from 0.05 mm to 0.075 mm, from 0.075 mm to 0.1 mm, from 0.1 mm to 0.125 mm, from 0.125 mm to 0.15 mm, from 0.15 mm to 0.175 mm, from 0.175 mm to 0.2 mm, from 0.2 mm to 0.225 mm, from 0.225 mm to 0.25, from 0.25 mm to 0.275 mm, from 0.275 mm to 0.3 mm, from 0.3 mm to 0.325 mm, from 0.325 mm to 0.35 mm, from 0.35 mm to 0.375 mm, from 0.375 mm to 0.4 mm, from 0.4 mm to 0.425 mm, from 0.425 mm to 0.45 mm, from 0.45 mm to 0.475 mm, or from 0.475 mm to 0.5 mm.

In any examples, the current collector can comprise from 50 wt. % to 99.999 wt. % Al. For example, the current collector can comprise from 50 wt. % to 60 wt. % Al, from 50 wt. % to 60 wt. % Al, from 50 wt. % to 70 wt. % Al, from 50 wt. % to 80 wt. % Al, from 50 wt. % to 90 wt. % Al, from 50 wt. % to 99.999 wt. % Al, from 60 wt. % to 70 wt. % Al, from 60 wt. % to 80 wt. % Al, from 60 wt. % to 90 wt. % Al, from 60 wt. % to 99.999 wt. % Al, from 70 wt. % to 80 wt. % Al, from 70 wt. % to 90 wt. % Al, from 70 wt. % to 99.999 wt. % Al, from 80 wt. % to 90 wt. % Al, from 80 wt. % to 99.999 wt. % Al, or from 90 wt. % to 99.999 wt. % Al.

Optionally, a coating layer may be disposed over at least a portion of a surface of the current collector. In any examples, the coating layer can comprise a carbonaceous material. Examples of the carbonaceous material can include a carbon black material or a Ketjenblack material. The coating layer can have a thickness of from 5 nm to 100 μm, such as from 5 nm to 50 nm, from 50 nm to 100 nm, from 100 nm to 150 nm, from 150 nm to 200 nm, from 200 nm to 250 nm, from 250 nm to 300 nm, from 300 nm to 350 nm, from 350 nm to 400 nm, from 400 nm to 450 nm, from 450 nm to 500 nm, from 500 nm to 550 nm, from 550 nm to 600 nm, from 650 nm to 700 nm, from 700 nm to 750 nm, from 750 nm to 800 nm, from 800 nm to 850 nm, from 850 nm to 900 nm, from 900 nm to 950 nm, from 950 nm to 1 μm, from 1 μm to 5 μm, from 5 μm to 10 μm, from 10 μm to 15 μm, from 15 μm to 20 μm, from 20 μm to 25 μm, from 25 μm to 30 μm, from 30 μm to 35 μm, from 35 μm to 40 μm, from 40 μm to 45 μm, from 45 μm to 50 μm, from 50 μm to 55 μm, from 55 μm to 60 μm, from 60 μm to 65 μm, from 65 μm to 70 μm, from 75 μm to 80 μm, from 80 μm to 85 μm, from 85 μm to 90 μm, from 90 μm to 95 μm, or from 95 μm to 100 μm. Optionally, the coating layer can completely coat the surface of the current collector. Alternatively, the coating layer can partially coat the surface of the current collector. In any examples, the coating layer can comprise a multilayer coating.

In any examples, the current collector may have one or more characteristics that are modified in a metal coating process to generate the coating layer. The one or more characteristics can include a surface area of the current collector, a surface roughness of the current collector, a surface oxide layer, electrical conductivity, thermal conductivity, corrosion resistance, chemical reactivity, electrolyte reactivity, active material reactivity, wetting character, or adhesion character. The electrical conductivity of the current collector can comprise from 30% IACS to 65% IACS, such as from 30% to 31% IACS, from 31% IACS to 32% IACS, from 33% IACS to 34% IACS, from 34% IACS to 35% IACS, from 35% IACS to 36% IACS, from 36% IACS to 37% IACS, from 37% IACS to 38% IACS, from 38% IACS to 39% IACS, from 40% IACS to 41% IACS, from 41% IACS to 42% IACS, from 42% IACS to 43% IACS, from 43% IACS to 44% IACS, from 44% IACS to 45% IACS, from 45% IACS to 46% IACS, from 46% IACS to 47% IACS, from 47% IACS to 48% IACS, from 48% IACS to 49% IACS, from 49% IACS to 50% IACS, from 50% IACS to 51% IACS, from 51% IACS to 52% IACS, from 52% IACS to 53% IACS, from 53% IACS to 54% IACS, from 54% IACS to 55% IACS, from 55% IACS to 56% IACS, from 56% IACS to 57% IACS, from 57% IACS to 58% IACS, from 58% IACS to 59% IACS, from 59% IACS to 60% IACS, from 60% IACS to 61% IACS, from 61% IACS to 62% IACS, from 62% IACS to 63% IACS, from 63% IACS to 64% IACS, from 64% IACS to 65% IACS.

In some aspects, methods are described herein, such as methods for making a battery component from a recycled content aluminum alloy. An example method of this aspect comprises providing a current collector that comprises a recycled content aluminum alloy; and subjecting a surface of the current collector to a coating process to generate a coating layer over at least a portion of the surface of the current collector. In some examples, the method further comprises subjecting the current collector or the coating layer to a further coating process to form a conductive layer. The conductive layer can comprise one or more of a carbonaceous material or a binder. In any examples, the coating process can comprise an immersion coating process or a roll-to-roll coating process. In any examples, the coating process can comprise plasma-assisted physical vapor deposition, plasma-activated physical vacuum deposition, plasma spray physical vapor deposition, vacuum plasma spraying, metal gun-spray deposition, plasma spraying, plasma transferred wire arc spraying, cold spraying, electro-chemical deposition, chemical deposition, sputtering, dip coating, or any combination thereof.

Current collectors made by the methods of this aspect may include any of the current collectors described herein.

Described herein are battery components that comprise an aluminum alloy foil produced from at least 50 wt. % recycled aluminum alloy materials, wherein the aluminum alloy foil has a thickness from 0.005 mm to 0.05 mm. The aluminum alloy foil may include a 3xxx series aluminum alloy or a 6xxx series aluminum alloy produced from at least 50 wt. % of recycled aluminum alloy materials. Similarly, in some examples, the aluminum alloy foil his produced from less than 20 wt. % primary aluminum. In some embodiments, the aluminum alloy foil comprises a first side and a second side, wherein at least one of the first side or the second side comprises a high reflective surface.

In some examples, the recycled aluminum alloy materials include recycled 1xxx series aluminum alloys, recycled 3xxx series aluminum alloys, recycled 5xxx series aluminum alloys, recycled 6xxx series aluminum alloys, recycled 8xxx series aluminum alloys, or combinations thereof. In any examples, the current collector can have a thickness from 0.005 mm to 0.5 mm, such as from 0.005 mm to 0.025 mm, from 0.025 mm to 0.05 mm, from 0.05 mm to 0.075 mm, from 0.075 mm to 0.1 mm, from 0.1 mm to 0.125 mm, from 0.125 mm to 0.15 mm, from 0.15 mm to 0.175 mm, from 0.175 mm to 0.2 mm, from 0.2 mm to 0.225 mm, from 0.225 mm to 0.25, from 0.25 mm to 0.275 mm, from 0.275 mm to 0.3 mm, from 0.3 mm to 0.325 mm, from 0.325 mm to 0.35 mm, from 0.35 mm to 0.375 mm, from 0.375 mm to 0.4 mm, from 0.4 mm to 0.425 mm, from 0.425 mm to 0.45 mm, from 0.45 mm to 0.475 mm, or from 0.475 mm to 0.5 mm.

In some examples, aluminum alloy foil comprises up to 0.80 wt. % Si, up to 0.80 wt. % Fe, up to 0.50 wt. % Cu, 0.07 wt. % to 1.40 wt. % Mn, 0.20 wt. % to 1.30 wt. % Mg, up to 0.50 wt. % Zn, up to 0.20 wt. % Cr, up to 0.10 wt. % Ti, and a remainder Al and unavoidable impurities. In some examples, the aluminum alloy foil comprises an aluminum alloy comprising greater than 0.05 wt. % Fe and greater than 0.05 wt. % Mn. In some examples, aluminum alloy foil comprises greater than 3.25 wt. % of alloying elements and the remainder Al, wherein the alloying elements comprise one or more of Si, Fe, Cu, Mn, Mg, Zn, Cr, and Ti. In some examples, the aluminum alloy foil is not subject to any artificial aging process. In various examples, the aluminum alloy foil is not subject to any solution heat treatment.

In some examples, the battery component forms a portion of a cathode current collector, an anode, busbars, interconnects, terminal leads, tabs, or cell container. In some examples, the battery component is a cathode current collector.

In some aspects, methods are described herein, such as methods for making a battery component. An example method of this aspect comprises casting an aluminum alloy comprising at least 50 wt. % recycled aluminum alloy material to produce a cast product, hot rolling the cast product to produce a hot rolled products, and cold rolling the hot rolled product to produce a cold rolled product. In some examples, the cold rolled product has a thickness from 0.005 mm to 0.05 mm. In some examples, the method may further include optionally homogenizing the cast product, optionally applying a heat treatment prior to cold rolling, and/or optionally interannealing the hot rolled product during cold rolling. In some examples, the cold rolled product has a thickness of less than 300 μm. In some examples, the cold rolled product is rolled in a foil mill. In some examples, the aluminum alloy is not subject to any artificial aging process or solution heat treatment.

In yet other aspects, described herein are aluminum alloy products for battery applications. The aluminum alloy product includes an aluminum alloy foil produced from from 3xxx series aluminum alloy comprising at least 50 wt. % recycled aluminum alloy materials comprising recycled 3xxx series aluminum alloys, recycled 6xxx series aluminum alloys, or combinations thereof. The aluminum alloy foil has a thickness of from 0.005 mm to 0.05 mm. In some examples, the aluminum alloy product is used as a component of a battery.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1 provides a schematic overview of an example method for making a recycled content aluminum alloy product.

FIG. 2 provides a schematic cross-sectional illustration of an example current collector comprising a recycled content aluminum alloy and a coating layer.

FIG. 3 provides a schematic cross-section illustrations of an example current collector comprising a recycled content aluminum alloy in a lithium-ion battery.

### DETAILED DESCRIPTION

Described herein are battery components such as current collectors that include recycled content aluminum alloys, optionally with a coating layer disposed over at least a portion of a surface of the current collector. In various examples, the recycled content aluminum alloys used in methods and products described herein include 2xxx series aluminum alloys, 3xxx series aluminum alloys, 3xxx series aluminum alloys, 4xxx series aluminum alloys, 5xxx series aluminum alloys, 6xxx series aluminum alloys, or 7xxx series aluminum alloys.

In some embodiments, the high recycle content aluminum alloys can be provided as an aluminum alloy foil having a thickness less than 20 microns. The high recycle content aluminum alloys may be used, for example, in electronics applications, such as current collectors or electrodes for batteries, electrochemical cells, capacitors, supercapacitors, or the like. For example, the high recycle content aluminum alloys can be used as current collectors for electrochemical cells and more specifically to aluminum current collectors used in electrochemical cell. In some embodiments, the high recycle content aluminum alloys can be used to form a portion of a cathode current collector, an anode, busbars, interconnects, terminal leads, tabs, or a cell container. In some embodiments, the current collectors include the recycled content aluminum alloys described herein, optionally with a coating layer disposed over at least a portion of a surface of the current collector. In various examples, the recycled content aluminum alloys used in methods and products described herein include 1xxx series aluminum alloys, 2xxx series aluminum alloys, 3xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys.

In the context of lithium or lithium-ion batteries, or battery applications, relatively pure aluminum alloys such as 1xxx series aluminum alloys or 8xxx series aluminum alloys are commonly used as a current collector on the cathode side, and copper is typically used as a current collector on the anode side. But using current collectors made from recycled content aluminum alloys may be more sustainable than using relatively pure aluminum alloys. Beneficially, the high recycle content aluminum alloys described herein can be used to replace high prime content aluminum alloys typically used in battery applications. In some examples, depending on the non-aluminum materials present in the recycled content aluminum alloys, current collectors made from recycled content aluminum alloys may have increased stability, conductivity, and longevity. In other examples, characteristics such as stability and conductivity may decrease with the use of recycled content aluminum alloys in current collectors.

For example, recycled content aluminum alloys may have an electrical conductivity that is from 30% to 50% of the electrical conductivity of a relatively pure aluminum alloy, such as an aluminum alloy with 99.99% Al or more. The use of recycled content aluminum alloys that, in some cases may lower electrical conductivity, can go against conventional teaching where high electrical conductivity is desired, by providing increased sustainability of aluminum products. Additionally, a coating layer can be disposed over the current collector to protect the non-aluminum elements within the recycled content aluminum alloy from coming into contact with lithium in a lithium-ion battery. The coating layer may prevent or limit corrosion and degradation of the current collector, and may increase the stability and conductivity of the current collector.

Components for batteries generally require a combination of mechanical properties that are well suited for aluminum alloys including, for example, electrical conductivity, strength, and density. The mechanical properties of the aluminum alloy are important for both complex battery manufacturing process and for in-service life where thermal and other stresses are repeatedly cycled over the lifetime of the component. While high purity aluminum alloys (e.g., 1xxx series aluminum alloys) are best for conductivity, 3xxx or 6xxx series aluminum alloys provide for higher strength which is particularly important as the thickness of the aluminum alloy is reduced, for example, when used as a foil. Throughout this disclosure references are made to lithium-ion batteries, however, this is merely one example and the high recycle content aluminum alloys described herein can be used in any secondary battery (e.g., sodium-ion or any other type of secondary battery chemistry).

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm). The term sheet also encompasses aluminum alloy products that may be referred to as foils, which may have a thickness of up to 500 μm, such as from about 1 μm to about 500 μm, for example.

Reference may be made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked. A W condition or temper refers to an aluminum alloy after solution heat treatment.

As used herein, a “high recycle content” aluminum alloy refers to an aluminum alloy that is produced from at least 50% recycled aluminum materials.

As used herein, a “high prime” or “high prime content” aluminum alloy refers to an aluminum alloy that is produced predominantly from primary aluminum, or pure aluminum melted directly from the electrolytic reduction of aluminum oxide.

As used herein, “rechargeable” or “secondary” batteries include, for example, lithium-ion, sodium-ion and other chemistries that generate energy through a chemical reaction and can both store and release electrical energy repeatedly.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

In the following examples, aluminum alloy products and their components may be described in terms of their elemental composition in weight percent (wt. %). In each alloy, the remainder is aluminum, with a maximum wt. % of 0.15% for the sum of all impurities.

Incidental elements, such as grain refiners and deoxidizers, or other additives may be present in the invention and may add other characteristics on their own without departing from or significantly altering the alloy described herein or the characteristics of the alloy described herein.

Unavoidable impurities, including materials or elements may be present in an alloy in minor amounts due to inherent properties of aluminum or leaching from contact with processing equipment. Some alloys, as described, may contain no more than about 0.25 wt. % of any element besides the alloying elements, incidental elements, and unavoidable impurities.

### Methods of Producing the Alloys and Aluminum Alloy Products

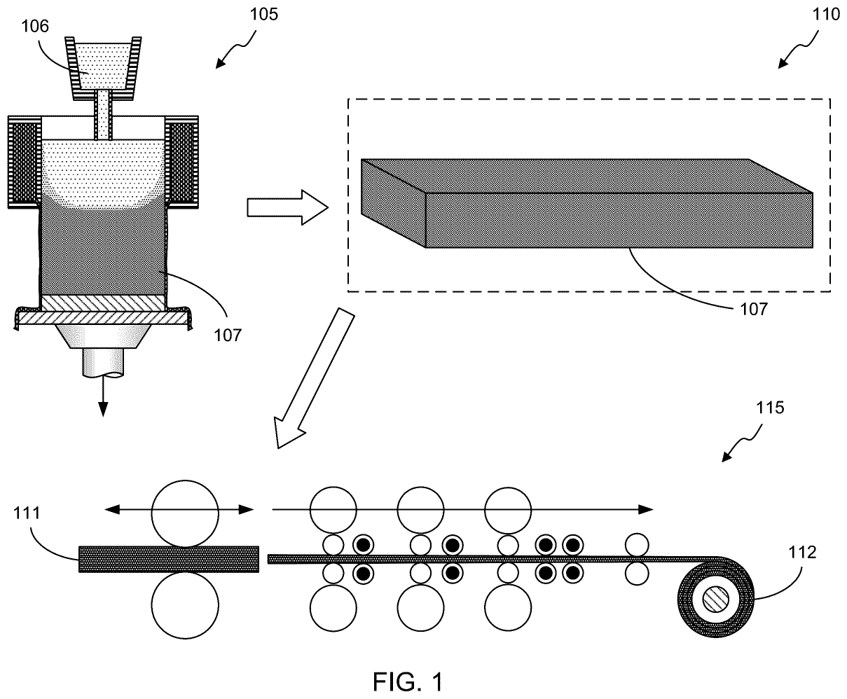

The aluminum alloy products described herein, such as aluminum sheet metal and aluminum foils, can be prepared by casting using the methods described herein. FIG. 1 provides a schematic overview of an example method for making a recycled content aluminum alloy product. The method of FIG. 1 may begin at step 105 where a recycled content aluminum alloy 106 may be cast to create a cast aluminum alloy product 107, such as an ingot or other cast product. At step 110, the cast aluminum alloy product 107 may be homogenized to form a homogenized aluminum alloy product 111. At step 115, the homogenized aluminum alloy product 111 may be subjected to one or more hot rolling passes and/or one or more cold rolling passes to form a rolled aluminum alloy product 112, which may correspond to an aluminum alloy article, such as an aluminum alloy plate, an aluminum alloy shate, or an aluminum alloy sheet. Optionally, the rolled aluminum alloy product 112 may be subjected to one or more forming or stamping processes to form an aluminum alloy article.

The recycled content aluminum alloys described herein can be cast using any suitable casting method known to those of ordinary skill in the art. As a few non-limiting examples, the casting process can include a direct chill (DC) casting process or a continuous casting (CC) process. The continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

A clad layer can be attached to a core layer to form a cladded product by any means known to persons of ordinary skill in the art. For example, a clad layer can be attached to a core layer by direct chill co-casting (i.e., fusion casting) as described in, for example, U.S. Pat. Nos. 7,748,434 and 8,927,113, both of which are hereby incorporated by reference in their entireties; by hot and cold rolling a composite cast ingot as described in U.S. Pat. No. 7,472,740, which is hereby incorporated by reference in its entirety; or by roll bonding to achieve metallurgical bonding between the core and the cladding. The initial dimensions and final dimensions of the clad aluminum alloy products can be determined by the desired properties of the overall final product.

A roll bonding process can be carried out in different manners. For example, the roll-bonding process can include both hot rolling and cold rolling. Further, the roll bonding process can be a one-step process or a multi-step process in which the material is gauged down during successive rolling steps. Separate rolling steps can optionally be separated by other processing steps, including, for example, annealing steps, cleaning steps, heating steps, cooling steps, and the like.

A cast ingot, cast slab, or other cast product can be processed by any suitable means. Such processing steps include, but are not limited to, homogenization, hot rolling, cold rolling, solution heat treatment, and an optional pre-aging step.

In some embodiments, a cast product can optionally be homogenized. In the homogenization step, a cast product is heated to a temperature ranging from about 400° C. to about 560° C. For example, the cast product can be heated to a temperature of about 400° C., about 410° C., about 420° C., about 430° C., about 440° C., about 450° C., about 460° C., about 470° C., about 480° C., about 490° C., about 490° C., about 500° C., about 510° C., about 520° C., about 520° C., about 540° C., about 550° C., or about 560° C. In some examples, homogenization is performed at a temperature within 50° C. of a solidus temperature of the cast product or alloy thereof. The product is then allowed to soak (i.e., held at the indicated temperature) for a period of time to form a homogenized product. In some examples, the total time for the homogenization step, including the heating and soaking phases, can be up to 24 hours. For example, the product can be heated up to 500° C. and soaked, for a total time of up to 18 hours for the homogenization step. Optionally, the product can be heated to below 490° C. and soaked, for a total time of greater than 18 hours for the homogenization step. In some cases, the homogenization step comprises multiple processes. In some non-limiting examples, the homogenization step includes heating a cast product to a first temperature for a first period of time followed by heating to a second temperature for a second period of time. For example, a cast product can be heated to about 465° C. for about 3.5 hours and then heated to about 480° C. for about 6 hours.

Following a homogenization step, a hot rolling step can be performed. Prior to the start of hot rolling, the homogenized product can be allowed to cool to a temperature between 300° C. to 450° C. For example, the homogenized product can be allowed to cool to a temperature of between 325° C. to 425° C. or from 350° C. to 400° C. The homogenized product can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product that can be allowed to cool to a temperature between 300° C. to 450° C. For example, the continuously cast product can be allowed to cool to a temperature of between 325° C. to 425° C. or from 350° C. to 400° C. The continuously cast products can then be hot rolled at a temperature between 300° C. to 450° C. to form a hot rolled plate, a hot rolled shate, or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). During hot rolling, temperatures and other operating parameters can be controlled so that the temperature of the hot rolled intermediate product upon exit from the hot rolling mill is no more than 470° C., no more than 450° C., no more than 440° C., or no more than 430° C.

Cast, homogenized, or hot-rolled products can be cold rolled using cold rolling mills into thinner products, such as a cold rolled sheet. The cold rolled product can optionally have a gauge between about 0.1 mm to 10 mm, e.g., between about 0.7 mm to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. In the case of foils, the cold rolled sheet can have a gauge of from about 1 μm to 500 μm, such as from 10 μm to 100 μm. The cold rolling can be performed to result in a final gauge thickness that represents a gauge reduction of up to 85% (e.g., up to 10%, up to 20%, up to 30%, up to 40%, up to 50%, up to 60%, up to 70%, up to 80%, or up to 85% reduction) as compared to a gauge prior to the start of cold rolling. Optionally, an interannealing step can be performed during the cold rolling step, such as where a first cold rolling process is applied, followed by an annealing process (interannealing), followed by a second cold rolling process. The interannealing step can be performed at a temperature of from about 300° C. to about 450° C. (e.g., about 310° C., about 320° C., about 330° C., about 340° C., about 350° C., about 360° C., about 370° C., about 380° C., about 390° C., about 400° C., about 410° C., about 420° C., about 430° C., about 440° C., or about 450° C.). In some cases, the interannealing step comprises multiple processes. In some non-limiting examples, the interannealing step includes heating the partially cold rolled product to a first temperature for a first period of time followed by heating to a second temperature for a second period of time. For example, the partially cold rolled product can be heated to about 410° C. for about 1 hour and then heated to about 330° C. for about 2 hours.

Subsequently, a cast, homogenized, or rolled product can optionally undergo a solution heat treatment step. The solution heat treatment step can be any suitable treatment for the sheet which results in solutionizing of the soluble particles. The cast, homogenized, or rolled product can be heated to a peak metal temperature (PMT) of up to 590° C. (e.g., from 400° C. to 590° C.) and soaked for a period of time at the PMT to form a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes).

After heating and soaking, the hot product is rapidly cooled, such as at rates greater than 200° C./s, to a temperature between 500 and 200° C. to form a heat-treated product. In one example, the hot product is cooled at a quench rate of above 200° C./second at temperatures between 450° C. and 200° C. Optionally, the cooling rates can be faster in other cases.

After quenching, the heat-treated product can optionally undergo a pre-aging treatment by reheating before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that generates or emits radiant heat, convective heat, induction heat, infrared heat, or the like. In some embodiments, the aluminum alloy is not subject to any artificial aging process. Similarly, in some embodiments, the aluminum alloy foil described herein is not subject to any artificial aging process.

The cast products described herein can be used to make products in the form of sheets, plates, foils or other suitable products. For example, plates including the products as described herein can be prepared by processing an ingot in a homogenization step or casting a product in a continuous caster followed by a hot rolling step. In the hot rolling step, the cast product can be hot rolled to a 200 mm thick gauge or less (e.g., from about 10 mm to about 200 mm). For example, the cast product can be hot rolled to a plate having a final gauge thickness of about 10 mm to about 175 mm, about 15 mm to about 150 mm, about 20 mm to about 125 mm, about 25 mm to about 100 mm, about 30 mm to about 75 mm, or about 35 mm to about 50 mm. In some cases, plates may be rolled into thinner metal products, such as sheets.

In some cases, the cast products described herein can be used to make foil. For preparation of foil, a small gauge can be achieved during cold rolling, such as about 0.2 mm, followed by a separate foil rolling process, where the cold rolled product can be rolled to a gauge of from about 1 μm to about 300 μm (e.g., 0.001 mm to 0.30 mm). In some examples, a foil may be rolled using a foil rolling process to a gauge of 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, from 10 μm to 50 μm, from 50 μm to 100 μm, from 100 μm to 150 μm, from 150 μm to 200 μm, from 200 μm to 250 μm, or from 250 μm to 300 μm. In some embodiments, the cold rolled product can be rolled in a foil mill.

In some examples, the rolled aluminum alloy product 112 may be provided or prepared for use as a current collector. A surface of the current collector can be subjected to a coating process to generate a coating layer over at least a portion of the surface of the current collector. The coating process may be a metal coating process that modifies one or more characteristics of the current collector. The characteristics can include a surface area of the current collector, a surface roughness of the current collector, a surface oxide layer, electrical conductivity, thermal conductivity, corrosion resistance, chemical reactivity, electrolyte reactivity, active material reactivity, wetting character, or adhesion character.

In some embodiments, the aluminum alloy foils described herein can be used to produce, for example, a cathode current collector. In some embodiments, the aluminum alloy foil may have opposite surface configurations (e.g., one matte and one shiny (or high reflective surface)) due to the rolling methods used to produce the aluminum alloy foil. In some examples, aluminum foils may be produced in pairs, such as where a first aluminum alloy substrate is positioned adjacent to a second aluminum alloy substrate during the rolling process to produce a pair of foils, sometimes referred to as a double rolled foil. In such a configuration, the surfaces of the foils that face one another will have dull or matte surfaces, while the surfaces of the foils that contact the rolling equipment will have bright or shiny surfaces. Dual rolling may be advantageously used for preparation of foils, for example, because such a rolling process may allow for increased production, since two foils can be produced during a single set of rolling operations.

For some aluminum alloy current collectors, it may be desirable for both surfaces to have shiny surface configurations. In some examples, this may be to improve battery production consistency or for improved battery performance. In some cases, preparing aluminum foils, such as for use as aluminum alloy current collectors, where both top and bottom surfaces are shiny surfaces may be achieved by a single layer rolling. In this way, both top and bottom surfaces of a single foil layer may be in contact with the roll and result in both surfaces having a shiny appearance.

For other aluminum alloy current collectors, it may be desirable for both surfaces to have matte surface configurations. In some examples, this may provide operational benefits or improved battery performance, such as where adhesion with active material is better as compared to adhesion with the shiny side. Accordingly, in an aspect, methods are described herein for preparing aluminum foils where both surfaces of the foils have matte configurations.

### Methods of Using the Disclosed Aluminum Alloy Products

The aluminum alloy products described herein can be used in battery applications. For example, the aluminum alloy products and methods described herein can be used to prepare components for electronic devices, including batteries, mobile phones, and tablet computers. In some examples, the aluminum alloy products can be used to prepare current collectors and electrodes used in electrochemical cells, capacitors, or batteries, which can be used in mobile phones, tablet computers, automotive, transportation, or the like.

Devices are also described herein, such as a device comprising aluminum alloy foil, such as any of those aluminum alloy products described herein. In some examples, a device comprises: an aluminum alloy layer, such as an aluminum alloy layer corresponding to a current collector for an electrode; and an electrode active material in contact with the current collector. Such a device may comprise or correspond to an electrochemical cell electrode. Optionally, electrode active material comprises a lithium-ion cathode active material or a lithium-ion anode active material. Optionally, the device may comprise or correspond to an electrochemical cell or a battery.

In some examples, the aluminum alloy foil layer and the electrode active material comprise or correspond to a first electrochemical cell electrode, and the device may further comprise a second electrochemical cell electrode and an electrolyte positioned between the first electrochemical cell electrode and the second electrochemical cell electrode. In this way, the device may optionally correspond to an electrochemical cell.

Optionally, the device may further comprise electronic device circuitry in direct or indirect electrical communication with and drawing or receiving current from the first electrochemical cell electrode or the second electrochemical cell electrode. For example, the device may comprise or correspond to a portable electronic device.

### Recycled Content Aluminum Alloys

The high recycled content aluminum alloys described herein can be produced from one or more recycled aluminum alloys. In some examples, the aluminum alloys for use to produce the high recycle content aluminum alloys described herein can include 1xxx series aluminum alloys, for example, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. In some examples, a current collector or the generated coating layer may be subjected to a further coating process to form a conductive layer. The conductive layer may comprise one or more of a carbonaceous material or a binder. Examples of the carbonaceous material can include a carbon black material or a Ketjenblack material. In some examples, the coating process can be an immersion coating process or a roll-to-roll coating process.

In any examples, the current collector and the coating layer can be subject to a further coating process that can form an electrode active material layer over the coating layer. In any eaxmples, the coating process can be plasma-assisted physical vapor deposition, plasma-activated physical vacuum deposition, plasma spray physical vapor deposition, vacuum plasma spraying, metal gun-spray deposition, plasma spraying, plasma transferred wire arc spraying, cold spraying, electro-chemical deposition, chemical deposition, sputtering, dip coating, immersion coating process a roll-to-roll coating process, or any combination thereof.

In any examples, the metals for use in the methods and products described herein include aluminum alloys, for example, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. In some examples, the materials for use in the methods and products described herein include non-ferrous materials, including aluminum, aluminum alloys, magnesium, magnesium-based materials, magnesium alloys, magnesium composites, titanium, titanium-based materials, titanium alloys, copper, copper-based materials, composites, sheets used in composites, or any other suitable metal, non-metal or combination of materials. Monolithic as well as non-monolithic, such as roll-bonded materials, cladded alloys, clad layers, composite materials, such as but not limited to carbon fiber-containing materials, or various other materials are also useful with the methods and products described herein. In some examples, aluminum alloys containing iron are useful with the methods and products described herein.

By way of non-limiting example, exemplary 1xxx series aluminum alloys can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

By way of non-limiting example, exemplary 2xxx series aluminum alloys for use in the methods and products described herein can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series aluminum alloys for use in the methods and products described herein can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series aluminum alloys for use in the methods and products described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series aluminum alloys for use in the methods and products described herein product can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series aluminum alloys for use in the methods and products described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series aluminum alloys for use in the methods and products described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series aluminum alloys can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

As one example, the high recycle content aluminum alloy can have the following elemental composition as provided in Table 1.

TABLE 1

| Element | Weight Percentage (wt. %) |
|---|---|
| Si | Up to 0.80 |
| Fe | Up to 0.80 |
| Cu | Up to 0.30 |
| Mn | 0.30-1.40 |
| Mg | 0.20-1.30 |
| Cr | Up to 0.20 |
| Zn | Up to 0.40 |
| Ti | Up to 0.10 |
| Others | 0-0.05 (each) |
| | 0-0.25 (total) |

In some examples, an aluminum alloy as described herein can have the following elemental composition as provided in Table 2.

TABLE 2

| Element | Weight Percentage (wt. %) |
|---|---|
| Si | 0.05-0.80 |
| Fe | 0.05-0.80 |
| Cu | 0.05-0.30 |
| Mn | 0.30-1.40 |
| Mg | 0.20-1.30 |
| Cr | Up to 0.20 |
| Zn | Up to 0.40 |
| Ti | Up to 0.10 |
| Others | 0-0.05 (each) |
| | 0-0.25 (total) |
| Si | Up to 0.80 |
| Fe | Up to 0.80 |

In some examples, an aluminum alloy as described herein can have the following elemental composition as provided in Table 3.

TABLE 3

| Element | Weight Percentage (wt. %) |
|---|---|
| Si | 0.05-0.70 |
| Fe | 0.05-0.70 |
| Cu | 0.05-0.25 |
| Mn | 0.30-1.25 |
| Mg | 0.20-1.10 |
| Cr | Up to 0.15 |
| Zn | Up to 0.30 |
| Ti | Up to 0.10 |
| Others | 0-0.05 (each) |
| | 0-0.25 (total) |
| Si | Up to 0.80 |
| Fe | Up to 0.80 |

### Silicon (Si)

In some examples, the aluminum alloy described herein includes Si in an amount up to 0.80 wt. % (e.g., from 0.05 wt. % to 0.80 wt. % or from 0.05 wt. % to 0.70 wt. %) based on the total weight of the alloy. For example, the alloy can include 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.78%, 0.79%, or 0.80% Si. All expressed in wt. %.

### Iron (Fe)

In some examples, the aluminum alloy described herein includes Fe in an amount up to 0.80 wt. % (e.g., from 0.05 wt. % to 0.80 wt. % or from 0.05 wt. % to 0.70 wt. %) based on the total weight of the alloy. For example, the alloy can include 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.78%, 0.79%, or 0.80% Fe. All expressed in wt. %.

### Copper (Cu)

In some examples, the aluminum alloy described herein includes Cu in an amount up to 0.30 wt. % (e.g., from 0.05 wt. % to 0.30 wt. %, from 0.05 wt. % to 0.25 wt. % or from 0.05 wt. % to 0.20 wt. %) based on the total weight of the alloy. For example, the alloy can include 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, or 0.30% Cu. All expressed in wt. %.

### Manganese (Mn)

In some examples, the aluminum alloy described herein can include Mn in an amount from 0.30 wt. % to 1.40 wt. % (e.g., from 0.30 wt. % to 1.25 wt. %) based on the total weight of the alloy. For example, the alloy can include 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.78%, 0.79%, 0.80%, 0.81%, 0.82%, 0.83%, 0.84%, 0.85%, 0.86%, 0.88%, 0.89%, 0.91%, 0.92%, 0.93%, 0.94%, 0.95%, 0.96%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29%, 1.30%, 1.31%, 1.32%, 1.33%, 1.34%, 1.35%, 1.36%, 1.37%, 1.38%, 1.39%, or 1.40% Mn. All expressed in wt. %.

### Magnesium (Mg)

In some examples, the aluminum alloy described herein can include Mg in an amount of from 0.20 wt. % to 1.30 wt. % (e.g., from 0.25 wt. % to 1.10 wt. %) based on the total weight of the alloy. For example, the alloy can include 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.78%, 0.79%, 0.80%, 0.81%, 0.82%, 0.83%, 0.84%, 0.85%, 0.86%, 0.88%, 0.89%, 0.91%, 0.92%, 0.93%, 0.94%, 0.95%, 0.96%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29%, or 1.30% Mg. All expressed in wt. %.

### Chromium (Cr)

In some examples, the aluminum alloy described herein includes Cr in an amount of up to 0.20% (e.g., up to 0.15% or up to 0.10%) based on the total weight of the alloy. For example, the alloy can include 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, or 0.20% Cr. In some cases, Cr is not present in the alloy (i.e., 0%). All expressed in wt. %.

### Zinc (Zn)

In some examples, the aluminum alloy described herein includes Zn in an amount of up to 0.40 wt. % (e.g., up to 0.30 wt. % or up to 0.25 wt. %) based on the total weight of the alloy. For example, the alloy can include 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, or 0.40% Zn. In some cases, Zn is not present in the alloy (i.e., 0%). All expressed in wt. %.

### Titanium (Ti)

In some examples, the aluminum alloy described herein includes Ti in an amount of up to 0.10% (e.g., up to 0.05%) based on the total weight of the alloy. For example, the alloy can include 0.01%, 0.02%, 0.03%, 0.04%, 0.05%, 0.06%, 0.07%, 0.08%, 0.09%, or 0.10% Ti. In some cases, Ti is not present in the alloy (i.e., 0%). All expressed in wt. %.

### Minor Elements

Optionally, the aluminum alloys described herein can further include other minor elements, sometimes referred to as impurities, in amounts of 0.05% or below, 0.04% or below, 0.03% or below, 0.02% or below, or 0.01% or below. These impurities may include, but are not limited to Ti, Sc, V, Ni, Hf, Zr, Sn, Ga, Ca, Bi, Na, Pb, or combinations thereof. Accordingly, Ti, Sc, V, Ni, Hf, Zr, Sn, Ga, Ca, Bi, Na, or Pb may be present in alloys in amounts of 0.05% or below, 0.04% or below, 0.03% or below, 0.02% or below, or 0.01% or below. In some embodiments, the aluminum alloy described herein includes Ni in an amount of up to 0.030 wt. %. In some embodiments, the aluminum alloy described herein includes Ti in an amount of up to 0.04 wt. % (e.g., up to 0.03 wt. %, up to 0.02 wt. %, up to 0.01 wt. %, or from 0.012-0.030 wt. %). In some embodiments, the aluminum alloy described herein includes V in an amount of up to 0.10 wt. % (e.g., up to 0.90 wt. %, up to 0.80 wt. %, up to 0.70 wt. %, up to 0.60 wt. %, up to 0.05 wt. %, up to 0.04 wt. %, up to 0.03 wt. %, up to 0.02 wt. %, or up to 0.01 wt. %). The sum of all impurities does not exceed 0.25% (e.g., 0.1%). All expressed in wt. %. The remaining percentage of each alloy is aluminum.

### Battery Components

The recycled content aluminum alloy products, such as foils or sheets, described herein can be used to make battery components, such as electronic substrates, which may be suitable for use in applications as a current collector or a device incorporating such a current collector, such as an electrode, an electrochemical cell, battery or a capacitor. In some examples, the recycled content aluminum alloy may be provided as a sheet or a foil. In some embodiments, foils or sheets described herein can be used to produce a portion of a cathode current collector, an anode, busbars, interconnects, terminal leades, tabs, or a cell container. For use as a current collector, the recycled content aluminum alloy layer may be coated with or otherwise in contact with a coating layer, which may also be referred to herein as a protection layer or a conductive protection layer. The recycled content aluminum alloy may alternatively be provided as a coating over a coating layer, which may optionally comprise a metal or metal alloy foil. In some cases, both the recycled content aluminum alloy and the coating layer may comprise foils.

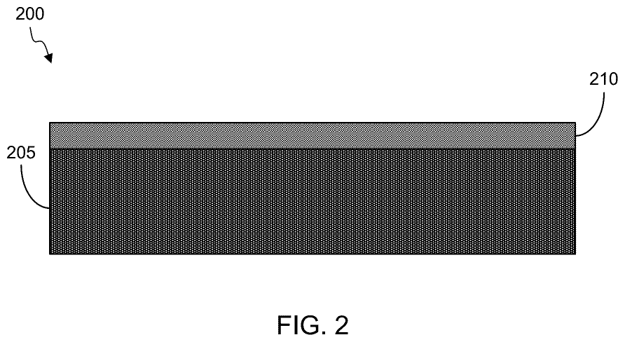

FIG. 2 provides a schematic cross-sectional illustration of an example current collector 200 comprising a recycled content aluminum alloy 205 and a coating layer 210 disposed over a surface of the recycled content aluminum alloy 205. In the current collector 200, the coating layer 210 is shown in contact with only one surface or side of the recycled content aluminum alloy 205, but other configurations may be used, such as where the coating layer 210 is in contact with different edges, surfaces, or faces of the recycled content aluminum alloy 205. In any examples, the current collector 200 can have a thickness from 0.005 mm to 0.5 mm. For example, the current collector 200 can have a thickness from 0.005 mm to 0.5 mm, such as from 0.005 mm to 0.025 mm, from 0.025 mm to 0.05 mm, from 0.05 mm to 0.075 mm, from 0.075 mm to 0.1 mm, from 0.1 mm to 0.125 mm, from 0.125 mm to 0.15 mm, from 0.15 mm to 0.175 mm, from 0.175 mm to 0.2 mm, from 0.2 mm to 0.225 mm, from 0.225 mm to 0.25, from 0.25 mm to 0.275 mm, from 0.275 mm to 0.3 mm, from 0.3 mm to 0.325 mm, from 0.325 mm to 0.35 mm, from 0.35 mm to 0.375 mm, from 0.375 mm to 0.4 mm, from 0.4 mm to 0.425 mm, from 0.425 mm to 0.45 mm, from 0.45 mm to 0.475 mm, or from 0.475 mm to 0.5 mm.

In any examples, the recycled content aluminum alloy 205 may comprise from 50% to 100% recycled aluminum content. For example, the recycled content aluminum alloy 205 can include 50% recycled aluminum content, 51% recycled aluminum content, 52% recycled aluminum content, 53% recycled aluminum content, 54% recycled aluminum content, 55% recycled aluminum content, 56% recycled aluminum content, 57% recycled aluminum content, 58% recycled aluminum content, 59% recycled aluminum content, 60% recycled aluminum content, 61% recycled aluminum content, 62% recycled aluminum content, 63% recycled aluminum content, 64% recycled aluminum content, 65% recycled aluminum content, 66% recycled aluminum content, 67% recycled aluminum content, 68% recycled aluminum content, 69% recycled aluminum content, 70% recycled aluminum content, 71% recycled aluminum content, 72% recycled aluminum content, 73% recycled aluminum content, 74% recycled aluminum content, 75% recycled aluminum content, 76% recycled aluminum content, 77% recycled aluminum content, 78% recycled aluminum content, 79% recycled aluminum content, 80% recycled aluminum content, 81% recycled aluminum content, 82% recycled aluminum content, 83% recycled aluminum content, 84% recycled aluminum content, 85% recycled aluminum content, 86% recycled aluminum content, 87% recycled aluminum content, 88% recycled aluminum content, 89% recycled aluminum content, 90% recycled aluminum content, 91% recycled aluminum content, 92% recycled aluminum content, 93% recycled aluminum content, 94% recycled aluminum content, 95% recycled aluminum content, 96% recycled aluminum content, 97% recycled aluminum content, 98% recycled aluminum content, 99% recycled aluminum content, or 100% recycled aluminum content.

In some embodiments, the aluminum alloy foil described herein is produced from less than 20 wt. % primary aluminum. For example, less than 20 wt. %, less than 19 wt. %, less than 18 wt. %, less than 17 wt. %, less than 16 wt. %, less than 15 wt. %, less than 14 wt. %, less than 13 wt. %, less than 12 wt. %, less than 11 wt. %, less than 10 wt. %, less than 9 wt. %, less than 8 wt. %, less than 7 wt. %, less than 6 wt. %, less than 5 wt. %, less than 4 wt. %, less than 3 wt. %, less than 2 wt. %, or less than 1 wt. % primary aluminum.

In any examples, the recycled content aluminum alloy 205 may include from 50 wt. % to 99.999 wt. % Aluminum (Al). For example, the recycled content aluminum alloy 205 may include from 50 wt. % to 60 wt. % Al, from 50 wt. % to 60 wt. % Al, from 50 wt. % to 70 wt. % Al, from 50 wt. % to 80 wt. % Al, from 50 wt. % to 90 wt. % Al, from 50 wt. % to 99.999 wt. % Al, from 60 wt. % to 70 wt. % Al, from 60 wt. % to 80 wt. % Al, from 60 wt. % to 90 wt. % Al, from 60 wt. % to 99.999 wt. % Al, from 70 wt. % to 80 wt. % Al, from 70 wt. % to 90 wt. % Al, from 70 wt. % to 99.999 wt. % Al, from 80 wt. % to 90 wt. % Al, from 80 wt. % to 99.999 wt. % Al, or from 90 wt. % to 99.999 wt. % Al.

In some cases, the recycled content aluminum alloy 205 may be a 3xxx series aluminum alloy or a 5xxx series aluminum alloy. In other cases, the recycled content aluminum alloy 205 may be a 2xxx series aluminum alloy, a 4xxx series aluminum alloy, a 6xxx series aluminum alloy, or a 7xxx series aluminum alloy. In some examples, the recycled content aluminum alloy 205 may not include a 1xxx series aluminum alloy or an 8xxx series aluminum alloy.

The coating layer 210 may be useful for preventing materials from directly contacting the recycled content aluminum alloy 205, such as in current collector 200 applications for batteries. In some examples, the coating layer 210 may serve to block or otherwise prevent transmission of certain materials, such as to limit contact of those materials with the underlying recycled content aluminum alloy 205. Optionally, the coating layer 210 may be electrically conductive and allow electrons to pass to the recycled content aluminum alloy. In some examples, the coating layer 210 can be a carbonaceous material. Examples of the carbonaceous material can include a carbon black material or a Ketjenblack material.

The coating layer 210 can have any suitable thickness. Example thicknesses may be from 5 nm to 100 μm, such as from 5 nm to 50 nm, from 50 nm to 100 nm, from 100 nm to 150 nm, from 150 nm to 200 nm, from 200 nm to 250 nm, from 250 nm to 300 nm, from 300 nm to 350 nm, from 350 nm to 400 nm, from 400 nm to 450 nm, from 450 nm to 500 nm, from 500 nm to 550 nm, from 550 nm to 600 nm, from 650 nm to 700 nm, from 700 nm to 750 nm, from 750 nm to 800 nm, from 800 nm to 850 nm, from 850 nm to 900 nm, from 900 nm to 950 nm, from 950 nm to 1 μm, from 1 μm to 5 μm, from 5 μm to 10 μm, from 10 μm to 15 μm, from 15 μm to 20 μm, from 20 μm to 25 μm, from 25 μm to 30 μm, from 30 μm to 35 μm, from 35 μm to 40 μm, from 40 μm to 45 μm, from 45 μm to 50 μm, from 50 μm to 55 μm, from 55 μm to 60 μm, from 60 μm to 65 μm, from 65 μm to 70 μm, from 75 μm to 80 μm, from 80 μm to 85 μm, from 85 μm to 90 μm, from 90 μm to 95 μm, or from 95 μm to 100 μm.

Some example techniques for creating the coating layer 210 can include, but are not limited to a physical deposition process, a sputter deposition process, an evaporation deposition process, a chemical deposition process, an electrodeposition process, an electroplating process, a chemical vapor deposition process, or an atomic layer deposition process.

It may be desirable in some cases to achieve partial or complete encapsulation of a recycled content aluminum alloy 205 by a coating layer 210. For example, the coating layer 210 may partially coat the surface, or may completely coat the surface. Such a configuration may be achieved, for example, by using a non-directional deposition technique, such as an electrodeposition process, which can be a solution-phase process and result in complete coating or encapsulation of the recycled content aluminum alloy 205 by the coating layer 210. In some cases, the coating layer 210 may be a multilayer coating. Each layer of a multilayer coating may have the same or different compositions from other layers.

The coating layer 210 may be generated on the recycled content aluminum alloy 205 in a metal coating process that modifies one or more characteristics of the recycled content aluminum alloy 205. The one or more characteristics can include a surface area of the recycled content aluminum alloy 205, a surface roughness of the recycled content aluminum alloy 205, a surface oxide layer, electrical conductivity, thermal conductivity, corrosion resistance, active material reactivity, wetting character, or adhesion character. It may be beneficial for the coating layer 210 or the current collector 200 as a whole to have an electrical conductivity of from 30% IACS to 65% IACS. For example, the current collector 200 can have an electrical conductivity of from 30% IACS to 65% IACS, such as from 30% to 31% IACS, from 31% IACS to 32% IACS, from 33% IACS to 34% IACS, from 34% IACS to 35% IACS, from 35% IACS to 36% IACS, from 36% IACS to 37% IACS, from 37% IACS to 38% IACS, from 38% IACS to 39% IACS, from 40% IACS to 41% IACS, from 41% IACS to 42% IACS, from 42% IACS to 43% IACS, from 43% IACS to 44% IACS, from 44% IACS to 45% IACS, from 45% IACS to 46% IACS, from 46% IACS to 47% IACS, from 47% IACS to 48% IACS, from 48% IACS to 49% IACS, from 49% IACS to 50% IACS, from 50% IACS to 51% IACS, from 51% IACS to 52% IACS, from 52% IACS to 53% IACS, from 53% IACS to 54% IACS, from 54% IACS to 55% IACS, from 55% IACS to 56% IACS, from 56% IACS to 57% IACS, from 57% IACS to 58% IACS, from 58% IACS to 59% IACS, from 59% IACS to 60% IACS, from 60% IACS to 61% IACS, from 61% IACS to 62% IACS, from 62% IACS to 63% IACS, from 63% IACS to 64% IACS, from 64% IACS to 65% IACS.

### Methods of Using the Disclosed Recycled Content Aluminum Alloy Products

The recycled content aluminum alloy products described herein can be used in electronics applications. For example, the recycled content aluminum alloy products and methods described herein can be used to prepare components for electronic devices, including batteries, mobile phones, and tablet computers. In some examples, the recycled content aluminum alloy products can be used to prepare current collectors and electrodes used in electrochemical cells, capacitors, or batteries, which can be used in mobile phones, tablet computers, or the like.

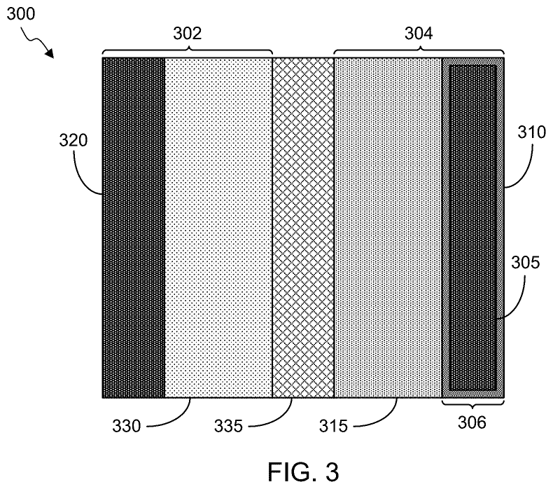

FIG. 3 provides schematic cross-section illustrations of an example current collector comprising a recycled content aluminum alloy 305 in a lithium-ion battery 300. The lithium-ion battery 300 includes a first electrode 302, which may correspond to a cathode in some examples, and a second electrode 304, which may correspond to an anode in some examples. The first electrode 302 of the lithium-ion battery 300 includes a first current collector 320. In some examples, the first current collector 320 may comprise a recycled content aluminum alloy. The first electrode 302 also includes a first active material 330, such as a cathode active material. The second electrode 304 of the lithium-ion battery 300 includes a recycled content aluminum alloy 305 (as a second current collector) and a coating layer 310. The second electrode 304 also includes a second active material 315, such as an anode active material. Although lithium-ion battery 300 depicted in FIG. 3 is described above with reference to current collector 320 being uncoated and current collector 306 including coating 310, such configuration is not intended to be limiting and one or both current collector 320 and current collector 306 can include a coating layer or can exclude a coating layer.

Lithium-ion battery 300 also includes a separator and/or an electrolyte, illustrated as component 335. A separator and/or electrolyte are useful for preventing the first electrode active material and the second electrode active material from contacting one another while still allowing ions to be transported across during charging or discharging. Example separators may be or include non-reactive porous materials, such as polymeric membranes like polypropylene, poly(methyl methacrylate), or polyacrylonitrile. Example electrolytes may be or include an organic solvent, such as ethylene carbonate, dimethyl carbonate, or diethyl carbonate, or solid or ceramic electrolytes. Electrolytes may include dissolved lithium salts, such as LiPF6, LiBF4, or LiClO4, and other additives.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### ILLUSTRATIVE ASPECTS

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a battery component, comprising a current collector comprising a recycled content aluminum alloy; and a coating layer disposed over at least a portion of a surface of the current collector.

Aspect 2 is the battery component of any preceding or subsequent aspect, wherein the current collector comprises from 50% to 100% recycled aluminum content.

Aspect 3 is the battery component of any preceding or subsequent aspect, wherein the current collector comprises a 3xxx series aluminum alloy or a 5xxx series aluminum alloy.

Aspect 4 is the battery component of any preceding or subsequent aspect, wherein the current collector has a thickness from 0.005 mm to 0.5 mm.

Aspect 5 is the battery component of any preceding or subsequent aspect, wherein the current collector does not include a 1xxx series aluminum alloy or an 8xxx series aluminum alloy.

Aspect 6 is the battery component of any preceding or subsequent aspect, wherein the current collector comprises a 2xxx series aluminum alloy, a 4xxx series aluminum alloy, a 6xxx series aluminum alloy, or a 7xxx series aluminum alloy.

Aspect 7 is the battery component of any preceding or subsequent aspect, wherein the current collector comprises from 50 wt. % to 99.9 wt. % Al.

Aspect 8 is the battery component of any preceding or subsequent aspect, wherein the current collector comprises from 80 wt. % to 99 wt. % Al.

Aspect 9 is the battery component of any preceding or subsequent aspect, wherein the coating layer comprises a carbonaceous material.

Aspect 10 is the battery component of any preceding or subsequent aspect, wherein the carbonaceous material comprises a carbon black material or a Ketjenblack material.

Aspect 11 is the battery component of any preceding or subsequent aspect, wherein the coating layer has a thickness of from 5 nm to 100 μm.

Aspect 12 is the battery component of any preceding or subsequent aspect, wherein the coating layer completely coats the surface of the current collector or wherein the coating layer partially coats the surface of the current collector.

Aspect 13 is the battery component of any preceding or subsequent aspect, wherein the coating layer comprises a multilayer coating.

Aspect 14 is the battery component of any preceding or subsequent aspect, wherein one or more characteristics of the current collector are modified in a metal coating process to generate the coating layer over at least a portion of the surface of the current collector, and wherein the one or more characteristics of the current collector comprise a surface area of the current collector, a surface roughness of the current collector, a surface oxide layer, electrical conductivity, thermal conductivity, corrosion resistance, chemical reactivity, electrolyte reactivity, active material reactivity, wetting character, or adhesion character.

Aspect 15 is the battery component of any preceding or subsequent aspect, wherein the electrical conductivity of the current collector is from 30% IACS to 65% IACS.

Aspect 16 is a method of making a battery component, the method comprising: providing a current collector, wherein the current collector comprises a recycled content aluminum alloy; and subjecting a surface of the current collector to a coating process to generate a coating layer over at least a portion of the surface of the current collector.

Aspect 17 is the method of any previous or subsequent aspect, wherein the coating process modifies one or more characteristics of the current collector, such as surface characteristics.

Aspect 18 is the method of any previous or subsequent aspect, wherein the one or more characteristics of the current collector comprise a surface area of the current collector, a surface roughness of the current collector, a surface oxide layer, electrical conductivity, thermal conductivity, corrosion resistance, chemical reactivity, electrolyte reactivity, active material reactivity, wetting character, or adhesion character.

Aspect 19 is the method of any previous or subsequent aspect, further comprising: subjecting the current collector or the coating layer to a further coating process to form a conductive layer, wherein the conductive layer comprises one or more of a carbonaceous material or a binder.

Aspect 20 is the method of any previous or subsequent aspect, wherein the coating process comprises an immersion coating process or a roll-to-roll coating process.

Aspect 21 is the method of any previous or subsequent aspect, further comprising: subjecting the current collector and coating layer to a further coating process to form an electrode active material layer over the coating layer.

Aspect 22 is the method of any previous or subsequent aspect, wherein the coating process comprises plasma-assisted physical vapor deposition, plasma-activated physical vacuum deposition, plasma spray physical vapor deposition, vacuum plasma spraying, metal gun-spray deposition, plasma spraying, plasma transferred wire arc spraying, cold spraying, electro-chemical deposition, chemical deposition, sputtering, dip coating, an immersion coating process, a roll-to-roll coating process, or any combination thereof.

Aspect 23 is the method of any previous or subsequent aspect, wherein the battery component is the battery component of any previous aspect.

Aspect 24 is the battery component of any previous or subsequent aspect, wherein the battery component is prepared according to the method of any previous aspect.

Aspect 25 is a battery comprising the battery component of any previous or subsequent aspect.

Aspect 26 is the battery of any previous aspect comprising an anode active material; a cathode active material; and an electrolyte between the anode active material and the cathode active material, wherein the battery component is a current collector in electrical contact with the anode active material or the cathode active material.

Aspect 27 is a battery component comprising, an aluminum alloy foil produced from at least 50 wt. % recycled aluminum alloy materials; wherein the aluminum alloy foil has a thickness less from 0.005 mm to 0.05 mm.

Aspect 28 is the battery component of any preceding or subsequent aspect, wherein the aluminum alloy foil comprises a 3xxx series aluminum alloy or a 6xxx series aluminum alloy produced from at least 50% of recycled aluminum alloy materials.

Aspect 29 is the battery component of any preceding or subsequent aspect, wherein the aluminum alloy foil comprises a first side and a second side, wherein at least one of the first side or the second side comprises a high reflective surface.

Aspect 30 is the battery component of any preceding or subsequent aspect, wherein the recycled aluminum alloy materials comprise recycled 1xxx series aluminum alloys, recycled 3xxx series aluminum alloys, recycled 5xxx series aluminum alloys, recycled 6xxx series aluminum alloys, recycled 8xxx series aluminum alloys, or combinations thereof.

Aspect 31 is the battery component of any preceding or subsequent aspect, wherein aluminum alloy foil has a thickness from 0.005 mm to 0.025 mm.

Aspect 32 is the battery component of any preceding or subsequent aspect, wherein aluminum alloy foil is produced from less than 20 wt. % primary aluminum.

Aspect 33 is the battery component of any preceding or subsequent aspect, wherein aluminum alloy foil comprises up to 0.80 wt. % Si, up to 0.80 wt. % Fe, up to 0.50 wt. % Cu, 0.07 wt. % to 1.40 wt. % Mn, 0.20 wt. % to 1.30 wt. % Mg, up to 0.50 wt. % Zn, up to 0.20 wt. % Cr, up to 0.10 wt. % Ti, and a remainder Al and unavoidable impurities.

Aspect 34 is the battery component of any preceding or subsequent aspect, wherein aluminum alloy foil comprises an aluminum alloy comprising greater than 0.05 wt. % Fe and greater than 0.05 wt. % Mn.

Aspect 35 is the battery component of any preceding or subsequent aspect, wherein aluminum alloy foil comprises greater than 3.25 wt. % of alloying elements and the remainder Al, wherein the alloying elements comprise one or more of Si, Fe, Cu, Mn, Mg, Zn, Cr, and Ti.

Aspect 36 is the battery component of any preceding or subsequent aspect, wherein the battery component is part of a lithium-ion battery.

Aspect 37 is the battery component of any preceding or subsequent aspect, wherein the battery component forms a portion of a cathode current collector, an anode, busbars, interconnects, terminal leads, tabs, or cell container.

Aspect 38 is the battery component of any preceding or subsequent aspect, wherein the battery component is a cathode current collector.

Aspect 39 is the battery component of any preceding or subsequent aspect, wherein the aluminum alloy foil is not subject to any artificial aging processes.

Aspect 40 is the battery component of any preceding or subsequent aspect, wherein the aluminum alloy foil is not subject to any solution heat treatment.

Aspect 41 is a method of producing a battery component comprising, casting an aluminum alloy comprising at least 50 wt. % recycled aluminum alloy materials to produce a cast product, hot rolling the cast product to produce a hot rolled product, and cold rolling the hot rolled product to produce a cold rolled product.

Aspect 42 is the method of any previous or subsequent aspect, wherein the cold rolled product having a thickness from 0.005 mm to 0.05 mm.

Aspect 43 is the method of any previous or subsequent aspect, further comprising optionally homogenizing the cast product, optionally applying a heat treatment prior to cold rolling, and optionally interannealing the hot rolled product during cold rolling.

Aspect 44 is the method of any previous or subsequent aspect, further comprising rolling the cold rolled product to a thickness less than 0.30 mm.

Aspect 45 is the method of any previous or subsequent aspect, wherein the cold product is rolled in a foil mill.

Aspect 46 is the method of any previous or subsequent aspect, wherein the aluminum alloy is not subject to any artificial aging processes.

Aspect 47 is the method of any previous or subsequent aspect, wherein the aluminum alloy is not subject to any solution heat treatment.

Aspect 48 is an aluminum alloy product for battery applications comprising, an aluminum alloy foil produced from 3xxx series aluminum alloy comprising at least 50 wt. % recycled aluminum alloy materials comprising recycled 3xxx series aluminum alloys, recycled 6xxx series aluminum alloys, or combinations thereof; wherein the aluminum alloy foil has a thickness from 0.005 mm to 0.05 mm, wherein the aluminum alloy product is used as a component of a battery.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

What is claimed is:

1. A battery component comprising:
an aluminum alloy foil produced from at least 50 wt. % recycled aluminum alloy materials;
wherein the aluminum alloy foil has a thickness less from 0.005 mm to 0.05 mm.

2. The battery component of claim 1, wherein the aluminum alloy foil comprises a 3xxx series aluminum alloy or a 6xxx series aluminum alloy produced from at least 50% of recycled aluminum alloy materials.

3. The battery component of claim 1, wherein the aluminum alloy foil comprises a first side and a second side, wherein at least one of the first side or the second side comprises a high reflective surface.

4. The battery component of claim 1, wherein the recycled aluminum alloy materials comprise recycled 1xxx series aluminum alloys, recycled 3xxx series aluminum alloys, recycled 5xxx series aluminum alloys, recycled 6xxx series aluminum alloys, recycled 8xxx series aluminum alloys, or combinations thereof.

5. The battery component of claim 1, wherein aluminum alloy foil has a thickness from 0.005 mm to 0.025 mm.

6. The battery component of claim 1, wherein aluminum alloy foil is produced from less than 20 wt. % primary aluminum.

7. The battery component of claim 1, wherein aluminum alloy foil comprises up to 0.80 wt. % Si, up to 0.80 wt. % Fe, up to 0.50 wt. % Cu, 0.07 wt. % to 1.40 wt. % Mn, 0.20 wt. % to 1.30 wt. % Mg, up to 0.50 wt. % Zn, up to 0.20 wt. % Cr, up to 0.10 wt. % Ti, and a remainder Al and unavoidable impurities.

8. The battery component of claim 1, wherein aluminum alloy foil comprises an aluminum alloy comprising greater than 0.05 wt. % Fe and greater than 0.05 wt. % Mn.

9. The battery component of claim 1, wherein aluminum alloy foil comprises greater than 3.25 wt. % of alloying elements and the remainder Al, wherein the alloying elements comprise one or more of Si, Fe, Cu, Mn, Mg, Zn, Cr, and Ti.

10. The battery component of claim 1, wherein the battery component is part of a lithium-ion battery.

11. The battery component of claim 1, wherein the battery component forms a portion of a cathode current collector, an anode, busbars, interconnects, terminal leads, tabs, or cell container.

12. The battery component of claim 1, wherein the battery component is a cathode current collector.

13. The battery component of claim 1, wherein the aluminum alloy foil is not subject to any artificial aging processes.

14. The battery component of claim 1, wherein the aluminum alloy foil is not subject to any solution heat treatment.

15. A method of producing a battery component comprising:
casting an aluminum alloy comprising at least 50 wt. % recycled aluminum alloy materials to produce a cast product;
hot rolling the cast product to produce a hot rolled product; and
cold rolling the hot rolled product to produce a cold rolled product.

16. The method of claim 15, the cold rolled product having a thickness from 0.005 mm to 0.05 mm.

17. The method of claim 15, further comprising:
optionally homogenizing the cast product;
optionally applying a heat treatment prior to cold rolling; and/or
optionally interannealing the hot rolled product during cold rolling.

18. The method of claim 15, further comprising rolling the cold rolled product to a thickness less than 0.30 mm.

19. The method of claim 18, wherein the cold product is rolled in a foil mill.

20. The method of claim 15, wherein the aluminum alloy is not subject to any artificial aging processes.

21. The method of claim 15, wherein the aluminum alloy is not subject to any solution heat treatment.

22. An aluminum alloy product for battery applications comprising:
an aluminum alloy foil produced from 3xxx series aluminum alloy comprising at least 50 wt. % recycled aluminum alloy materials comprising recycled 3xxx series aluminum alloys, recycled 6xxx series aluminum alloys, or combinations thereof;
wherein the aluminum alloy foil has a thickness from 0.005 mm to 0.05 mm,
wherein the aluminum alloy product is used as a component of a battery.
